(19) United States
(12) Patent Application Publication
(10) Pub. No.: US 2025/0238584 A1
(43) Pub. Date: Jul. 24, 2025

(54) PREDICTION-BASED TERMINATION OF ANALOG CIRCUIT SIMULATIONS

(71) Applicant: Synopsys, Inc., Sunnyvale, CA (US)

(72) Inventors: Peilin JIANG, Santa Clara, CA (US); Mayukh BHATTACHARYA, Palo Alto, CA (US)

(21) Appl. No.: 18/418,031

(22) Filed: Jan. 19, 2024

(51) Int. Cl. G06F 30/3308; G06N 3/091

(52) U.S. Cl. CPC G06F 30/3308; G06N 3/091

(57) ABSTRACT

Prediction-based termination of analog circuit simulations, including generating training waveforms based on analog circuit simulations of a circuit design (CD) and fault-injected instances of the CD, labeling the waveforms of the fault-injected instances of the CD based on differences relative to the waveforms of the CD, and training an ML model to predict the labels based on the waveforms. CNN layers may be trained based on unlabeled training data generated from analog circuit simulations of fault-injected simplified CDs, layer-by-layer, based on an extreme learning machine (ELM) autoencoder. Classifier inputs may be determined from trained filter parameters of the CNN layers. Fully connected layers may be trained based on the waveforms of the CD and relatively few fault-injected instances of the CD, layer-by-layer, based on a random-sparse-matrix-based ELM autoencoder. Faults may be weighted based on likelihoods. Multiple ML models may be trained for respective stages of an analog circuit simulation.

### TECHNICAL FIELD

The present disclosure relates to circuit design, including prediction-based termination of analog circuit simulations.

### BACKGROUND

Analog circuit simulations may be performed for fault analysis and/or verification. Analog circuit simulations are computationally expensive in terms of time and computing resources, especially for transient simulation of large circuit designs. For example, analysis of spectral properties of a circuit design may be based on measurements in the frequency domain, which may be computed from Fourier transformations of transient responses design over an entire duration of an analog circuit simulation, which may take hours to complete, and which may be performed many times (e.g., tens, hundreds, or even thousands of times) as the circuit design progresses.

Moreover, a simulator may need to be configured to detect faults for a particular circuit design. As part of the configuration process, faults may be intentionally injected into the circuit design to determine whether the simulator can detect the faults. The number of potential faults of a circuit design can be astronomically high. For example, each transistor of a circuit design may be susceptible to multiple faults (e.g., four potential faults due to open or shorted terminals). A circuit design may include tens of thousands, or even millions of transistors. Testing the simulator for such vast numbers of potential faults may be prohibitively expensive in terms of computational time and computing resources.

### SUMMARY

Systems and methods of prediction-based termination of analog circuit simulations are disclosed herein. An example is a method that includes determining differences between waveforms generated during analog circuit simulations of a circuit design and fault-injected instances of the circuit design, labeling the waveforms generated during the analog circuit simulations of the fault-injected instances of the circuit design based on the differences, and training a machine learning (ML) model to predict the labels based on the waveforms generated during the analog circuit simulations of the circuit design and the fault-injected instances of the circuit design.

Another example is a non-transitory computer readable medium that includes stored instructions, which when executed by a processor, cause the processor to determine differences between waveforms generated during analog circuit simulations of a circuit design and fault-injected instances of the circuit design, label the waveforms generated during the analog circuit simulations of the fault-injected instances of the circuit design based on the corresponding differences, and train an ML model to predict the labels based on the waveforms generated during the analog circuit simulations of the fault-injected instances of the circuit design.

Another example is a system that includes memory that stores instructions, and a processor that executes the instructions, where the instructions, when executed, cause the processor to perform analog circuit simulations of a circuit design and fault-injected instances of the circuit design, output waveforms generated by the circuit design and the fault-injected instances of the circuit design during the respective analog circuit simulations, decompose the waveforms into multiscale components, determine differences between the waveforms generated by the circuit design and the corresponding waveforms generated by the fault-injected instances of the circuit design, and differences between the respective multiscale components, label the waveforms generated by the fault-injected circuit designs and the corresponding multiscale components based on the respective differences, and train an ML model to predict the labels based on the waveforms generated by the circuit design and the fault-injected instances of the circuit design, and the multiscale components.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a block diagram of a computing platform for prediction-based termination of analog circuit simulations, according to an embodiment.

FIG. 2 illustrates multiple ML models, according to an embodiment.

FIG. 3 is a block diagram of a computing platform that includes features of FIG. 1, and further includes a decomposition engine, according to an embodiment.

FIG. 4 illustrates an ML model architecture, according to an embodiment.

FIG. 5 illustrates operations of a convolutional layer of an ML model, according to an embodiment.

FIG. 6 is a block diagram of a computing platform 600 for prediction-based termination of analog circuit simulations, according to an embodiment.

FIG. 7 illustrates processes of the computing platform of FIG. 6, according to an embodiment.

FIG. 8 illustrates a method of training an ML model to predict an outcome of an analog circuit simulation, according to an embodiment.

FIG. 9 illustrates a method of using an ML model to predict an outcome of an analog circuit simulation, according to an embodiment.

FIG. 10 depicts a flowchart of various processes used during the design and manufacture of an integrated circuit in accordance with some embodiments of the present disclosure.

FIG. 11 depicts a diagram of an example computer system in which embodiments of the present disclosure may operate.

### DETAILED DESCRIPTION

Aspects of the present disclosure relate to prediction-based termination of analog circuit simulations. Prediction-based termination of analog circuit simulations utilizes one or more machine learning (ML) models to predict outcomes of analog circuit simulations based on waveforms of responses generated during the analog circuit simulations, such that the simulations may be terminated at relatively early stages of the simulations.

In an example, one or more ML models are trained with waveforms generated during analog circuit simulations of a nominal circuit design and fault-injected instances of the circuit design, to reveal relationships/correlations between performance of the circuit design during early stages of the simulations and performance of the circuit design over durations of the simulations, such that the ML model(s) can thereafter detect abnormal behavior of the circuit design, during early stages of subsequent analog circuit simulations.

Prediction accuracy of the ML model(s) depends in part on features extracted from the waveforms. As disclosed herein, convolutional neural network (CNN) layers and pooling layers of the ML models may be trained to perform feature extraction. Fully connected (FC) layers of the ML models are trained as classifiers (e.g., binary pass/fail classifiers). The CNN layers perform filtering and windowing to extract localized features of the waveforms.

In addition to waveforms generated during analog circuit simulations, multiscale components of the waveforms may be provided as input to a first one of the CNN layers. The CNN layers may include multiple channels to accommodate the waveforms and the multiscale components. The multiscale components may be obtained from finite difference of the time series (i.e., the waveforms) with different time step sizes, or signal decomposition (e.g., using wavelet transform or empirical Fourier decomposition). Consequently, local variations in the waveforms may be more pronounced in some of the multiscale components. Such multi-resolution capability may improve identification accuracy.

The CNN layers may be trained in tandem or combination with the FC layers of the classifier. Alternatively, transfer learning models may be employed to train filter parameters for the CNN layers based on waveforms (and multiscale components) generated from relatively fast simulations of numerous fault-injected instances of the circuit design (e.g., based on a simplified version of the circuit design and/or low-accuracy-level simulations). Inputs to the classifier (i.e., the first FC layer) may be determined based on the trained filter parameters of the CNN layers, and parameters of the classifier may be trained based on waveforms (and multiscale components) generated from (slower/higher-accuracy) simulations of relatively few fault-injected instances of the circuit design. Transfer learning models may be useful to reduce computational time/resources associated with generation of high-accuracy training data (i.e., waveforms).

The CNN layers of the feature extractor may be trained in tandem/combination with one another. Alternatively, the CNN layers may be trained separately from one another (i.e., layer-by-layer). The CNN layers may be trained based on an extreme learning machine (ELM) autoencoder. An autoencoder is a type of artificial neural network that learns an efficient encoding function for unlabeled data (unsupervised learning), and a decoding function that recreates the set of data from the encoding function. The encoding function may be useful for dimensionality reduction. An ELM randomly generates the parameters of the hidden nodes and never updates them, while determines the output weights via solving the least-square problem of a linear system. Training the CNN layers individually based on an ELM autoencoder may reduce training time and computational resources.

The FC layers may be trained layer-by-layer based on a sparse ELM autoencoder, which may reduce training time and computing resources, and may improve generalization of the ML model.

Prediction-based termination of analog circuit simulations may be useful to predict whether a circuit design will pass or fail a simulated analog fault detection test. Prediction-based termination of analog circuit simulations may also be useful for evaluating the ability of a simulator to detect faults of a circuit design. Prediction-based termination of analog circuit simulations may also be useful for verification of circuit designs and/or other applications.

Prediction-based termination of analog circuit simulations may reduce computational time and/or resources, which may permit more extensive/frequent analog circuit simulations, which may improve circuit designs, without adversely impacting a design cycle (e.g., time-to-fabrication and/or time-to-market).

Prediction-based termination of analog circuit simulations may reduce computational time and/or resources associated with generating training data, training ML models based on the training data, and/or performing analog circuit design simulations.

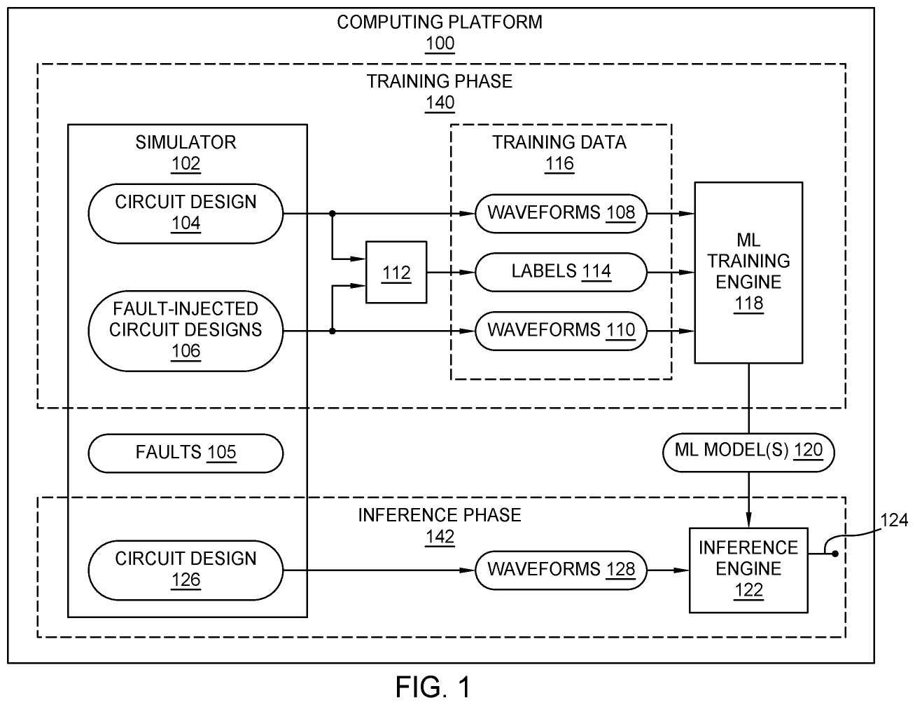

FIG. 1 is a block diagram of a computing platform 100 for prediction-based termination of analog circuit simulations, according to an embodiment. In the example of FIG. 1, computing platform 100 includes simulator 102 that performs analog simulations of a circuit design 104 and fault-injected circuit designs 106. Fault-injected circuit designs 106 may represent instances/versions of circuit design 104 that contain respective faults 105. Simulator 102 outputs waveforms 108 generated at nodes of circuit design 104 and waveforms 110 generated at corresponding nodes of fault-injected circuit designs 106 in response to stimulation from simulator 102.

Computing platform 100 may further include a labeling engine 112 that generates labels 114 for waveforms 110. In an example, for each of the nodes, labeling engine 112 compares the waveforms 110 generated by respective fault-injected circuit designs 106 to the waveform 108 generated by circuit design 104 (e.g., over durations of the respective analog circuit simulations). If the waveform 110 of a fault-injected circuit design 106 differs from the corresponding waveform 108 by more than a threshold amount, labeling engine 112 sets the label 114 for the waveform 110 to a first state (e.g., C=1), otherwise labeling engine 112 sets the label 114 a second state (e.g., C=0). Waveforms 108 and 110, and labels 114, may be collectively referred to as training data 116.

Computing platform 100 further includes an ML training engine 118 that trains one or more ML models 120, based on training data 116. ML training engine 118 may trains ML model(s) to predict labels 114 of waveforms 110 based on waveforms 108 and 110 of the corresponding nodes and/or based on waveforms 108 and 110 of multiple nodes.

Computing platform 100 further includes an inference engine 122 that uses ML model(s) 120 to provide a predicted outcome 124 of an analog circuit simulation of a circuit design 126 based on waveforms 128 generated at corresponding nodes of circuit design 126 during the analog circuit simulation of circuit design 126. Circuit design 126 may represent a version of circuit design 104. As an example, circuit design 126 may represent a fault-injected instance of circuit design 104 for determining whether simulator can detect an injected fault of circuit design 106. As another example, circuit design 126 may represent an instance of circuit design 104 undergoing analog circuit simulation for analog fault analysis and/or verification.

Computing platform 100 generates training data 116 and trains ML model 120 during a training phase 140 and predicts outcome 124 during an inference phase 142.

Computing platform 100 may include circuitry, which may include logic cells and/or a processor and memory that stores instructions for execution by the processor. Computing platform 100 may represent a single computing platform or multiple computing platforms, which may be centralized and/or distributed. For example, and without limitation, simulator 102, ML training engine 118, and/or inference engine 122 represent respective computing platforms. As another example, simulator 102 may represent multiple simulators (e.g., a first simulator that generates waveforms for training ML model(s) 120, and a second simulator that performs analog circuit simulations as part of a circuit design process).

ML training engine 118 may train multiple ML models 120 to predict outcome 124 at respective stages of the analog circuit simulation of circuit design 126, based on waveforms 128 generated during the respective stages of the analog circuit simulation. The ML models 120 may be trained for a sequence of successive stages of the analog circuit simulation, which may encompass a desired duration (e.g., an entire duration) of the analog circuit simulation. In an example, a number of steps of the duration is designated L, a number of ML models 120 is designated M, and a number of time steps in an m-th one of the ML models is represented as

$${I}_{m} = \frac{m L}{M} .$$

When simulator 102 performs the analog circuit simulation of circuit design 126, inference engine 122 may use the M ML models at successive stages of the analog circuit simulation. When the conclusion (i.e., predicted outcome 124) from a preceding one of ML models 120 is negative (i.e., does not predict failure of the analog circuit simulation), and the conclusion of a current one of ML models 120 is positive (i.e., predicts failure of the analog circuit simulation), the analog circuit simulation of circuit design 126 may be prematurely terminated. In the foregoing example, outputs of the M ML models are C. For the m-th ML model, the input in the training set is the waveforms of the first Iₘ time steps at all nodes, and the output is the corresponding C values.

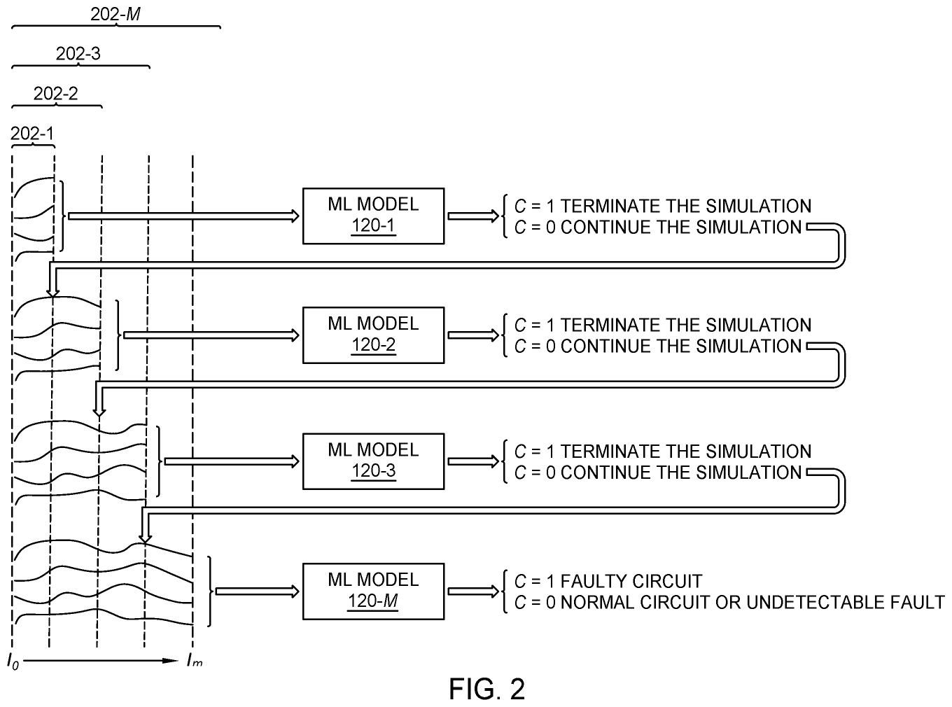

FIG. 2 illustrates multiple ML models 102-1 through 102-M, according to an embodiment. In the example of FIG. 2, ML training engine 118 trains ML model 120-1 based on waveforms 108 and 110 generated during a range 202-1 of time-steps I₀ through Iₘ. Training engine 118 trains ML models 102-2 through 102-M based on waveforms 108 and 110 generated during respective ranges 202-2 through 202-M of time-steps I₀ through Iₘ. In FIG. 2, each successive ML model 120 is trained based on waveforms generated over successively longer periods of time. The predicted outcome 124 of ML model 120-2 may thus be more reliable than the predicted outcome 124 of ML model 120-1. Similarly, the predicted outcome 124 of ML model 120-3 may be more reliable than the predicted outcome 124 of ML model 120-2, and the predicted outcome 124 of ML model 120-M may be more reliable than the predicted outcome 124 of ML model 120-3. Multiple ML models 120 are not limited to the examples of FIG. 2.

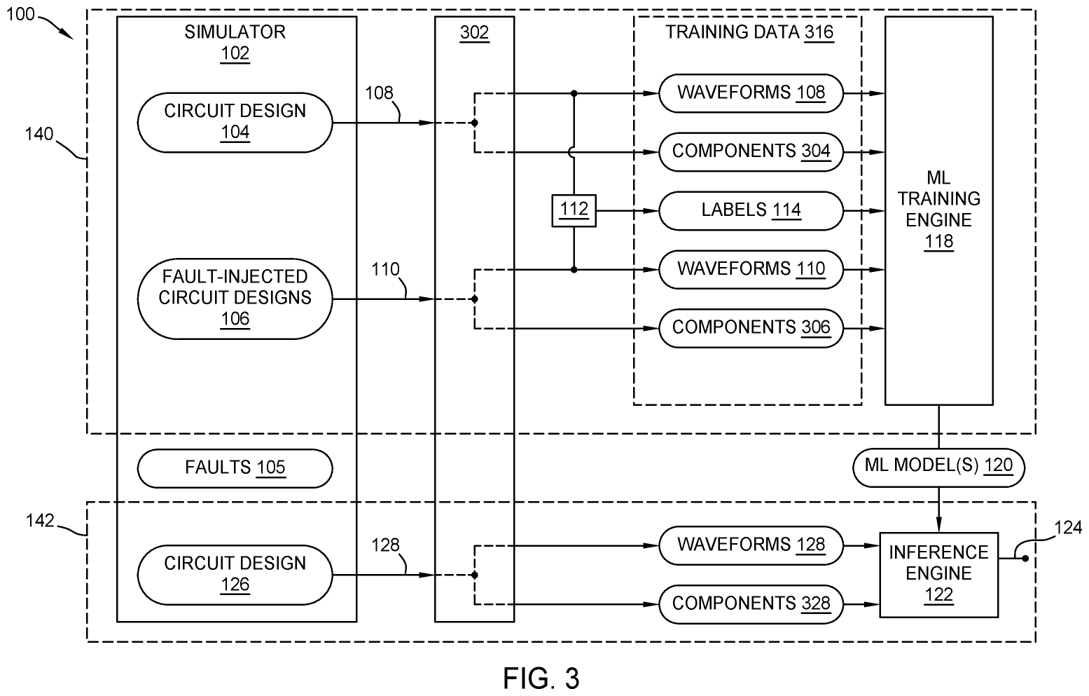

FIG. 3 is a block diagram of a computing platform 300 that includes features described above with respect to computing platform 100, and further includes a decomposition engine 302, according to an embodiment. Decomposition engine 302 provides multi-scale components 304, 306, and 328 of corresponding waveforms 108, 110, and 128. Decomposition engine 302 may provide multi-scale components 304, 306, and 328 based on finite differences of the time series (i.e., waveforms) with different time-step sizes, signal decomposition using wavelet transform, and/or empirical Fourier decomposition. Decomposition engine 302 may be useful to enhance localized variations of waveforms 108, 110, and 128. Decomposition engine 302 may provide multi-resolution capability, which may improve identification accuracy.

In the example of FIG. 3, training engine 118 trains ML model(s) 120 based on training data 316, which includes waveforms 108 and 110, multi-scale components 304 and 306, and labels 114 (i.e., training engine 118 trains ML model(s) 120 to predict labels 114 based on waveforms 108 and 110 and multi-scale components 304 and 306). Further in the example of FIG. 3, inference engine 122 predicts outcome 124 based on waveforms 128 and corresponding components 328.

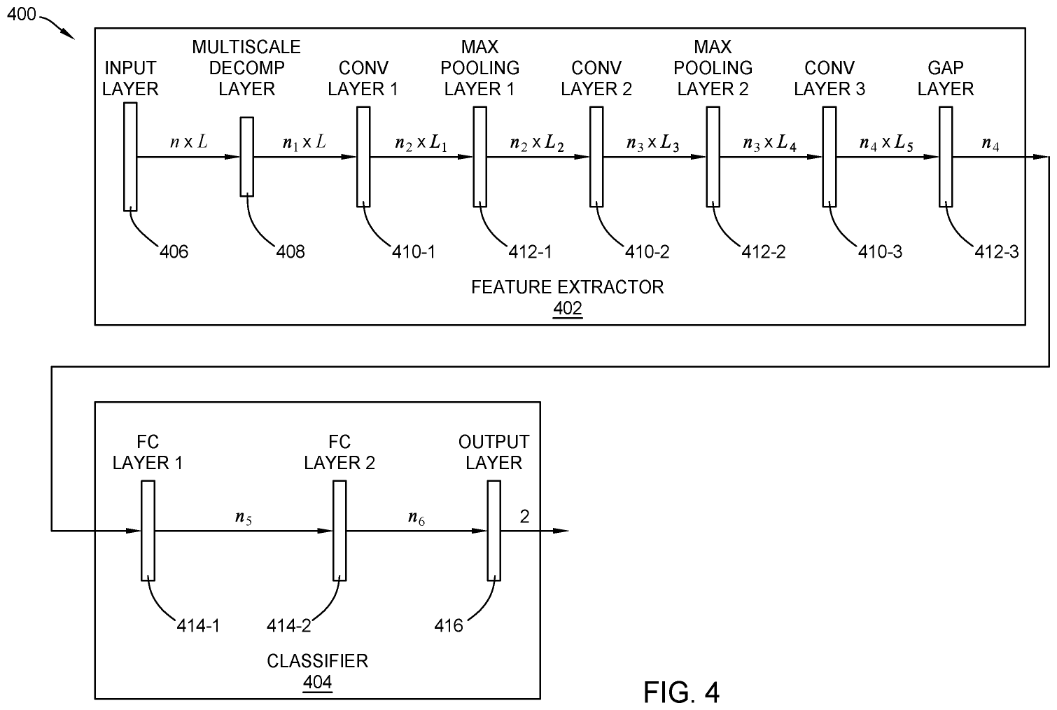

An example architecture of an ML model 120 is provided below with reference to FIG. 4. FIG. 4 illustrates a ML model architecture 400, according to an embodiment. In the example of FIG. 4, architecture 400 includes an input layer 406 that receives input waveforms (e.g., waveforms 128 of circuit design 126 during inference phase 142) from nodes of a circuit design. Architecture 400 further includes a multiscale decomposition layer 408 that performs multiscale decomposition of the input waveforms, which may be useful to resolve local variations. Multiscale decomposition layer 408 may perform an (empirical) wavelet transform, an empirical Fourier decomposition, and/or a finite difference of the time series to decompose the signals into multiscale components, similar to decomposition engine 302 in FIG. 3.

Architecture 400 further includes multiple consecutive convolutional neural network (CNN) layers 410-1, 410-2, and 410-3 (collectively, CNN layers 410), that perform feature extraction to detect local associations of features. CNN layers 410 are interleaved with pooling layers 412-1, 412-2, and 412-3 that reduce dimensionality. CNN layer 410-1 receives waveforms 128 and multiscale components of waveforms 128. Pooling layers 412-1 and 412-2 are max polling layers. Pooling layer 412-3 is global average pooling (GAP) layer, which reduces the dimension of inputs to GAP layer 412-3 and hence the number of parameters. GAP layer 412-3 also makes it possible for architecture 400 to accept waveforms of different lengths.

Architecture 400 further includes fully connected (FC) layers 414-1 and 414-2, and an output layer 416. Output layer 416 may perform binary classification (e.g., a 2-class softmax function).

Input layer 406, multi-scale decomposition layer 408, CNN layers 410, and pooling layers 412 may be collectively referred to as a feature extractor 402. FC layers 414 and output layer 416 may be collectively referred to as a classifier 404. Within feature extractor 402, n designates a number of channels and L designates a length of the time series (i.e., of waveforms 128). Within classifier 404, n designates dimensions of GAP layer 412-3 and FC layers 414.

CNN layers 410 include filters with trainable parameters that are determined/learned in training phase 140. ML training engine 118 may train the filter parameters and FC layers 414 together. Alternatively, ML training engine 118 may train CNN layers 410 separate from FC layers 414, which may reduce training time. ML training engine 118 may train CNN layers 410 separate from one another (i.e., layer-wise training) based on an autoencoder, which may further reduce training time. ML training engine 118 may include an extreme learning machine (ELM) to speed up layer-wise training.

During training phase 140, the input to CNN layer 410-1 includes waveforms 108 from the nodes of circuit design 104, waveforms 110 from the nodes of fault-injected circuit designs 106, multi-scale components 304 and 306, and labels 114. A length of the input is denoted L. The number of fault-injected circuit designs 106 is denoted N. The number of waveforms 110 and corresponding components 306 is denoted N_{ic}. CNN layer 410-1 convolves the input with filters of length K. To obtain better resolution, CNN layer 410-1 may include multiple channels of filters. The number of channels is denoted N_{oc}. Results of CNN layer 410-1 may be provided to a nonlinear activation function.

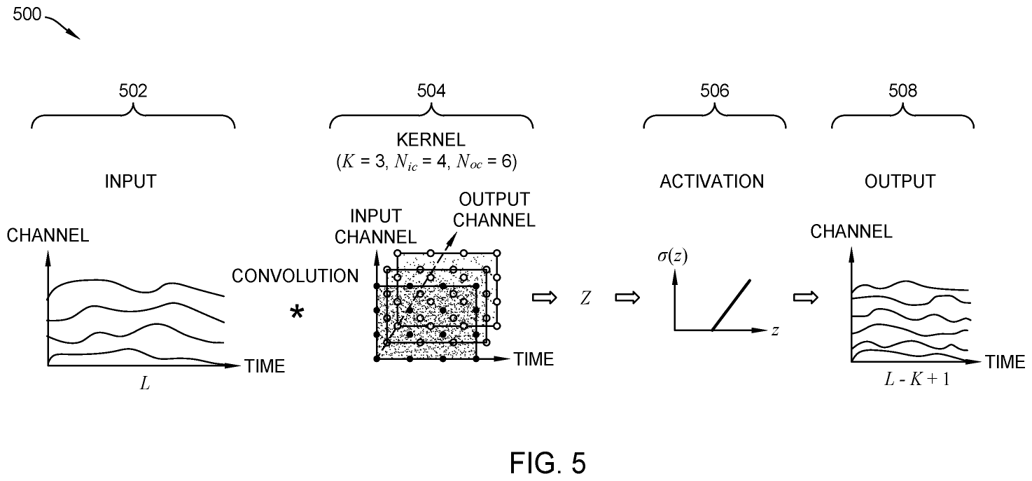

FIG. 5 illustrates operations of a CNN layer 500, according to an embodiment. In the example of FIG. 5, CNN layer 500 convolves an input 502 with a filter kernel 504, results of which are provided to an activation function 506, which provides an output 508.

ML training engine 118 may use an ELM autoencoder to train CNN layers. For CNN layer 410-1, ML training engine 118 may convert the input time series (e.g., waveforms 110) of each channel of each fault-injected circuit design 106 into a matrix, and may perform the convolution operation described above as a matrix-vector multiplication. ML training engine 118 may de-convolve the output of CNN layer 410-1 to reproduce the input. ML training engine 118, using the ELM autoencoder, may randomly generate the parameters of the filters, and may determine the parameters of de-convolution based on regularized linear regression. ML training engine 118 may perform the foregoing method as shown in Table 1, below.

TABLE 1

| | |
|---|---|
| Input: | Signals from different sources and their components. Denote the signal for one |
| | sample and one signal as x. |
| Output: | Filters F and bias B. |
| Method: | i. Normalize x into x̅. |
| | ii. Reshape x̅ into |
| | $Y = [ \begin{matrix}{\overline{x}}_{1} & {\overline{x}}_{2} & … & {\overline{x}}_{K - 1} & {\overline{x}}_{K} \\ {\overline{x}}_{2} & {\overline{x}}_{3} & … & {\overline{x}}_{K} & {\overline{x}}_{K + 1} \\ & & ⋮ & & \\ {\overline{x}}_{L - K} & {\overline{x}}_{L - K + 1} & … & {\overline{x}}_{L - 2} & {\overline{x}}_{L - 1} \\ {\overline{x}}_{L - K + 1} & {\overline{x}}_{L - K + 2} & … & {\overline{x}}_{L - 1} & {\overline{x}}_{L}\end{matrix} ] ,$ |
| | and augment Y as Yₐ = [Y\|1]. |
| | iii. Denote the above reshaped and augmented signal for the i-th sample |
| | and the j-th channel as Yₐᵢⱼ. For all samples and all channels, form X as |
| | X[i, j] = Yₐᵢⱼ, where i = 1̅,̅ N̅, j = 1̅,̅ N̅_̅{̅ι̅c̅}̅. |
| | iv. Randomly generate the elements of a matrix of size (N_{ic}(K + 1), N_{oc}) |
| | denoted as W. |
| | v. Calculate XW and apply the activation function σ on each element of |
| | the result, to provide H = σ(XW). |
| | vi. The output weights can be calculated as: |
| | $β = {arg min}_{β} ( {‖ H β - X ‖}_{2}^{2} + λ {\vert β \vert}_{1} ) , .$ |
| | which may be solved using a fast iterative shrinkage-thresholding |
| | method, which may provide a worst-case optimal convergence rate. |
| | vii. Extract the filter’s matrix and bias from the above output weights |
| | [F^{T}\|B^{T}] = β. |

The foregoing method provides fast training speed, even when the number of coefficients is large. In addition, L−1 regularization enhances generalization of the model.

For training PC layers (e.g., PC layers 414 in FIG. 4), ML training engine 118 may use an enhanced hierarchical ELM with a random sparse matrix-based autoencoder, which may reduce training time. Sparsity introduced in the autoencoder may also enhance a generalization capability of classifier 404.

As described further above, analog fault analysis may rely on numerical simulations to evaluate the electrical performance of faulty circuit designs. If fault-injected circuit designs 106 are numerous and/or complex, generation of training data 116 may consume significant computational time and/or resources. Methods for reducing computational time and resources are provided below.

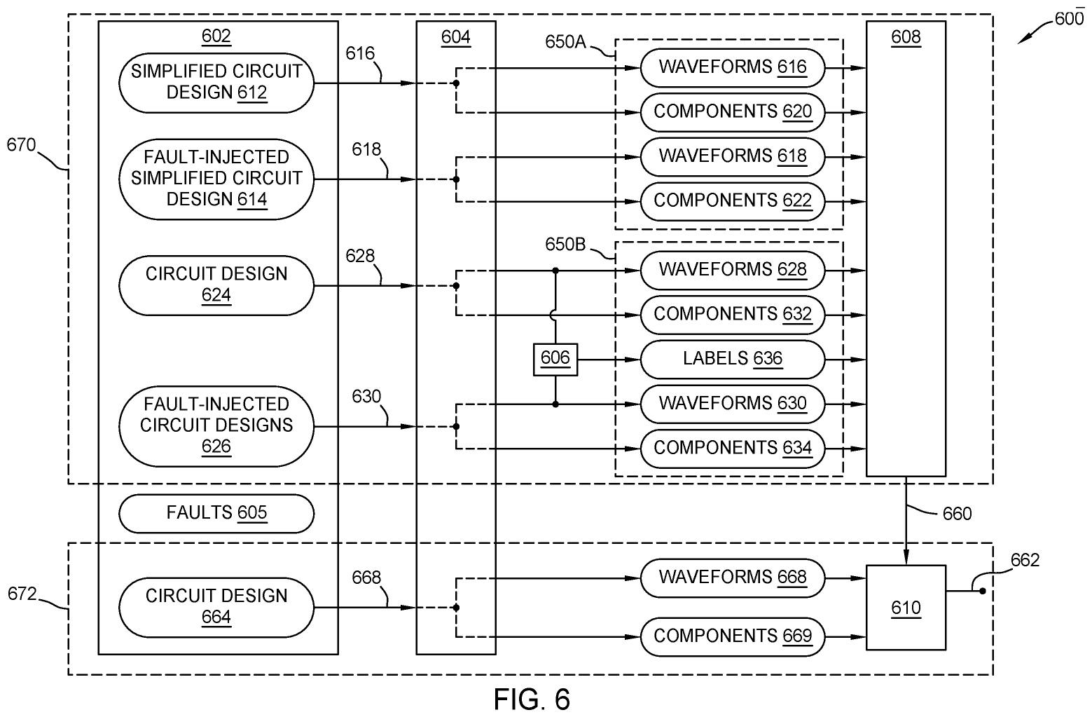

ML training engine 118 may employ transfer learning models that utilize correlations between results from high-fidelity (HF) models and low-fidelity (LF) models. ML training engine 118 may train the transfer learning models based on relatively low-accuracy/precision waveforms and/or simplified circuit designs, such as described below with reference to FIG. 6.

FIG. 6 is a block diagram of a computing platform 600 for prediction-based termination of analog circuit simulations, according to an embodiment. In the example of FIG. 6, computing platform 600 includes a simulator 602, a decomposition engine 604, and a labeling engine 606 that generates un-labeled training data 650A and labeled training data 650B (collectively, training data 650). Computing platform 600 further includes a training engine 608 that trains one or more ML models 660 based on training data 650, and an inference engine 610 that predicts outcome 662 of analog circuit simulations.

During a training phase 670, simulator 602 performs analog circuit simulations of a simplified circuit design 612, fault-injected simplified circuit designs 614, a circuit design 624, and fault-injected circuit designs 626, and outputs waveforms 616, 618, 628, and 630 from nodes of the corresponding circuit designs.

Simplified circuit design 612 may represent a relatively low-fidelity (i.e., reduced-complexity) version of circuit design 624. As an example, circuit design 624 may represent a physical layout or post-layout version of a circuit design, and simplified circuit design 612 may represent a pre-layout version (e.g., a schematic) of the circuit design. Alternatively, simplified circuit design 612 may represent a version of the circuit design (e.g., a physical layout or post-layout) in which selected elements/features are reduced or simplified (e.g., resistors may be shorted and/or capacitors may be removed). Fault-injected simplified circuit designs 614 may represent instances of simplified circuit design 612 that contain respective faults, which may be selected from faults 605. Fault-injected circuit designs 626 may represent instances of circuit design 624 that contain respective faults, which may be selected from a subset of faults 605.

Simulator 602 may perform analog circuit simulations at multiple levels of accuracy/precision. Simulator 602 may employ one of the multiple levels of accuracy/precision based on a level of complexity/simplicity of a circuit design. Simulator 602 may perform analog circuit simulations of simplified circuit design 612 and/or fault-injected simplified circuit designs 614 at a first level of accuracy/precision and may perform analog circuit simulations of circuit design 624 and/or fault-injected circuit designs 626 at a second level of precision or accuracy, where the second level of precision or accuracy is higher/greater than the first level of precision or accuracy. Performing analog circuit simulations of simplified circuit design 612 and/or fault-injected simplified circuit designs 614 at a lower level of precision or accuracy may reduce computational resources and time.

Simulator 602 may perform analog circuit simulations for a relatively large number of fault-injected simplified circuit designs 614 to generate waveforms 618 for a relatively large number of faults. Simulator 602 may perform analog circuit simulations for a relatively small number of fault-injected circuit designs 626 to generate waveforms 630 for a relatively small number of faults. Simulator 602 may perform analog circuit simulations for i fault-injected circuit designs 626 and j fault-injected simplified circuit designs 614, where i and j are positive integers and j is greater than i. As an example, and without limitation, i=a·j, where a is within a range of approximately 10 to 100. Methods and systems disclosed herein are not, however, limited to the foregoing example.

Decomposition engine 604 extracts multi-scale components 620, 622, 632, and 634 from corresponding waveforms 616, 618, 628, and 630, and labeling engine 606 determines labels 636 for waveforms 630, such as described further above with respect to labeling engine 112.

Training engine 608 trains filter parameters of CNN layers of ML model(s) 660 (e.g., CNN layers 410 in FIG. 4) based on unlabeled training data 650A. Training engine 608 may use ELM autoencoder-based layer-wise training, such as described further above. Training engine 608 uses the trained filter parameters to compute inputs to a first FC layer of ML model 660 (e.g., FC layer 414-1 in FIG. 4), and trains FC layers of ML model 660 (e.g., FC layers 414-1 and 414-2 in FIG. 4), based on labeled training data 650B.

The number of fault-injected simplified circuit designs 614 may be based on a number of faults or defects that may occur in circuit design 624. As an example, and without limitation, circuit design 624 may include 10,000 transistors, which may be susceptible to 4 types of injectable faults (e.g., shorted terminals and/or open terminal), for a total of 4×10,000=40,000 possible transistor faults. In this example, simulator 602 may inject 40,000, or a subset thereof, into a corresponding number of fault-injected simplified circuit designs 614. Simulator 602 may inject additional types of faults in additional fault-injected simplified circuit designs 614. In an example, each fault-injected simplified circuit designs 614 includes a single corresponding fault. In another example, one or more fault-injected simplified circuit designs 614 include multiple faults.

Simulator 602 may employ a weighted random sampling method to estimate likelihoods of different faults 605 and may use the estimated likelihoods to determine weights of the faults in random sampling (e.g., to select faults 605 for fault-injected simplified circuit designs 614 and fault-injected circuit designs 626). The weighted random sampling method may be useful to provide more training samples for critical faults, which may improve an effectiveness of training data 650 in terms of representativeness. The weighted random sampling method may also be useful to reduce the overall number of training samples, which may reduce time/computing resources expended by computing platform 600. Similarly, simulator 102 in FIG. 1 and/or FIG. 3 may use weighted random sampling to select faults 105 for fault-injected circuit designs 106.

During an inference phase 672, simulator 602 performs an analog circuit simulation of a circuit design 664 (e.g., for analog fault detection and/or verification), and outputs waveforms 668 from nodes of circuit design 664. In an example, circuit design 664 represents a fault-injected instance of circuit design 624, and simulator 602 performs analog circuit simulation for fault detection purposes. In another example, circuit design 664 represents circuit design 624 or a modification thereof, and simulator 602 performs analog circuit simulation for verification purposes.

Further in the inference phase 672, decomposition engine 604 extracts multi-scale components 669 from waveforms 668, and inference engine 610 predicts an outcome 662 of the analog circuit simulation of circuit design 664.

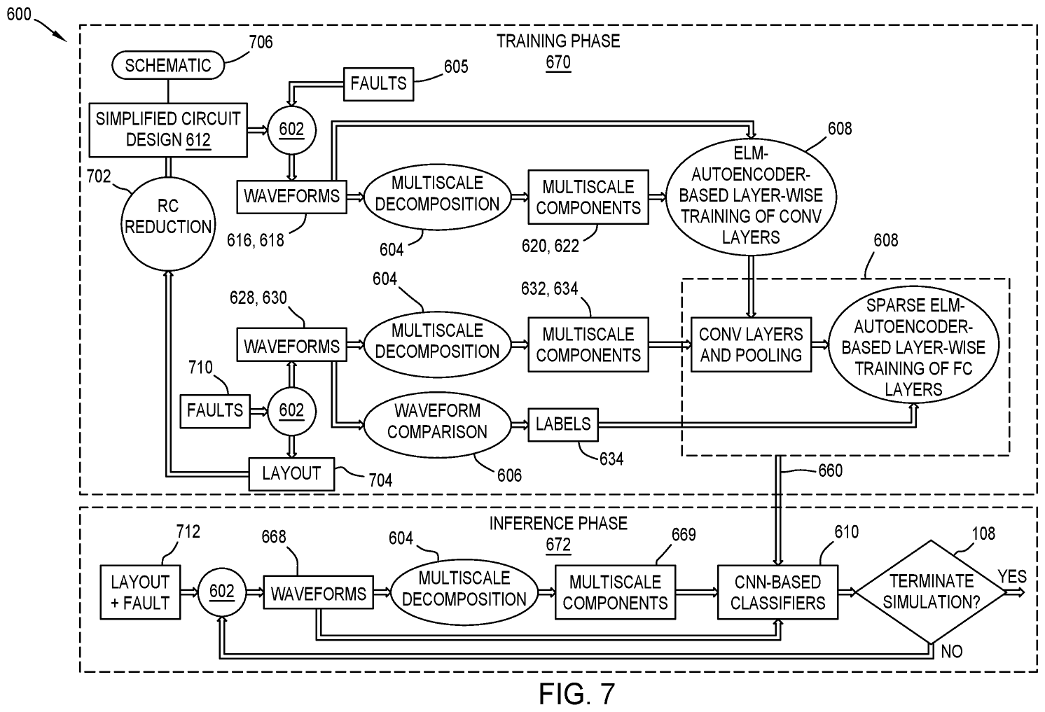

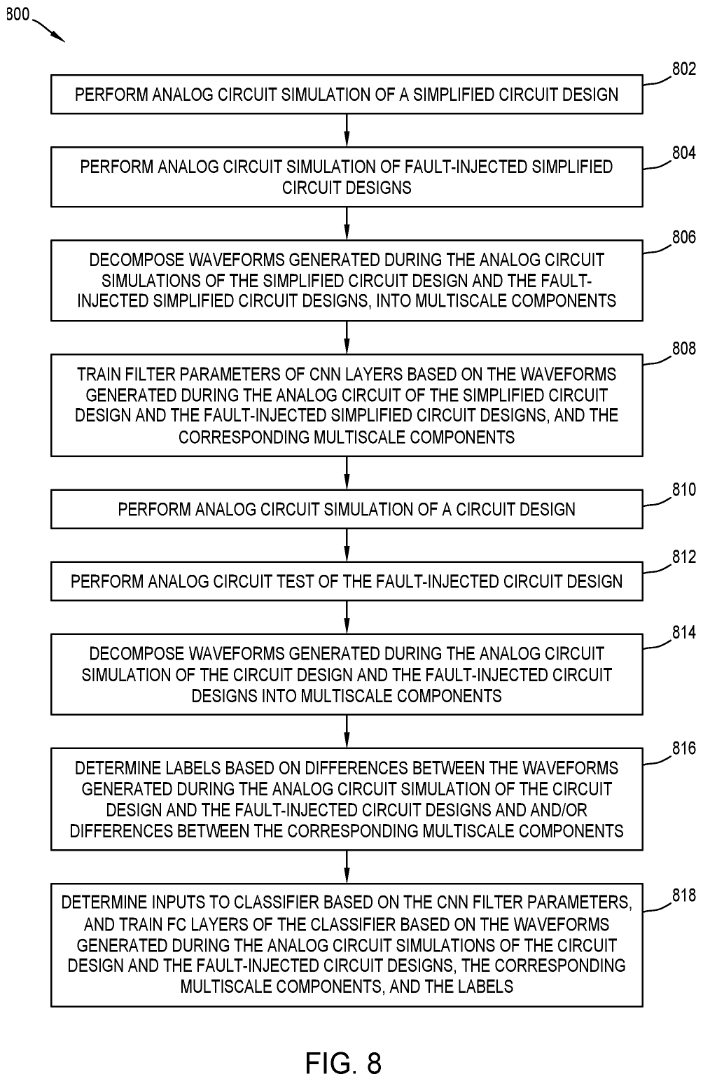

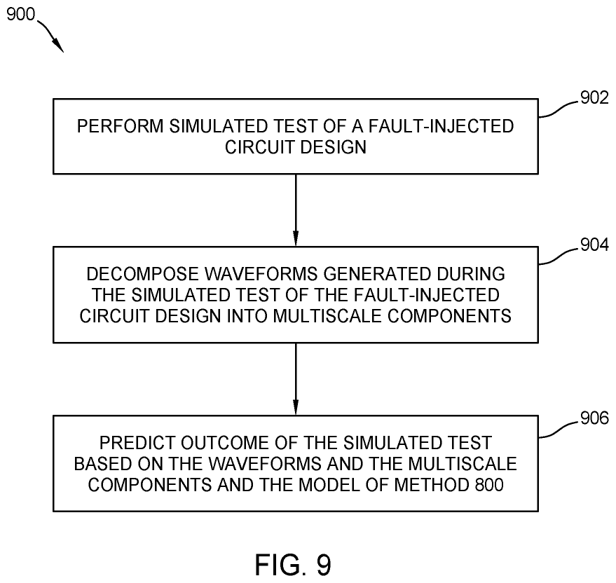

FIG. 7 illustrates processes of computing platform 600, according to an embodiment. FIG. 7 is described below with reference to FIGS. 8 and 9. FIG. 8 illustrates a method 800 of training an ML model to predict an outcome of an analog circuit simulation, according to an embodiment. FIG. 9 illustrates a method 900 of using the ML model to predict an outcome of an analog circuit simulation, according to an embodiment. Methods 800 and 900 are described below with reference to FIGS. 6 and 7. Methods 800 and 900 are not, however, limited to the examples of FIG. 6 or FIG. 7.

In FIG. 8, at 802, simulator 602 performs an analog circuit simulation of simplified circuit design 612 (e.g., at a relatively low level of accuracy/precision), and outputs waveforms 616 generated at nodes of simplified circuit design 612 during the analog circuit simulation. In FIG. 7, computing platform 600 may include an RC reduction engine 702 that simplifies a layout 704 of circuit design 624 (e.g., shorts resistors and/or removes capacitors) to provide simplified circuit design 612. Alternatively, simplified circuit design 612 may represent a schematic 706 of circuit design 624.

At 804, simulator 602 injects faults 605 into instances of simplified circuit design 612 to provide fault-injected simplified circuit designs 614, performs analog circuit simulations of fault-injected simplified circuit designs 614 (e.g., at the relatively low level of accuracy/precision), and outputs waveforms 618.

At 806, decomposition engine 604 decomposes waveforms 616 and 618 to provide multi-scale components 620 and 622.

At 808, training engine 608 trains the filter parameters of the CNN layers of ML model 660 (e.g., using ELM-autoencoder-based layer-wise training) based on waveforms 616 and 618, and multi-scale components 620 and 622 (i.e., unlabeled training data 650A).

At 810, simulator 602 performs analog circuit simulation of circuit design 624 (e.g., layout 704), and outputs waveforms 628 generated at the nodes of circuit design 624 during the analog circuit simulation. Simulator 602 may perform the analog circuit simulation at a relatively high level of accuracy/precision.

At 812, simulator 602 injects a relatively small number of faults 710 (e.g., critical faults of faults 605) into a correspondingly relatively small number of instances of circuit design 624, to provide fault-injected circuit designs 626, performs analog circuit simulation of fault-injected circuit designs 626, and outputs waveforms 668.

At 814, decomposition engine 604 decomposes waveforms 668 to provide multi-scale components 669.

At 816, labeling engine 606 generates labels 636 based on differences between waveforms 628 and 630, and/or based on differences between multi-scale components 632 and 634.

At 818, training engine 608 uses the filter parameters of the CNN layers trained at 810 to compute inputs to a first FC layer of ML model 660 (e.g., FC layer 414-1 in FIG. 4), and the trains FC layers of ML model 660 (e.g., FC layers 414-1 and 414-2 in FIG. 4), based on labeled training data 650B (i.e., waveforms 628 and 630, multi-scale components 632 and 634, and labels 636.

Method 800 may be performed for each of multiple ML models, such as described above with reference to FIG. 2.

In FIG. 9, at 902, simulator 602 performs an analog circuit simulation of circuit design 664 (e.g., layout and fault 712 in FIG. 7), and outputs waveforms 668 generated at the nodes of circuit design 664 during the analog circuit simulation. Simulator 602 may perform the analog circuit simulation at the relatively high level of accuracy/precision.

At 904, decomposition engine 604 decomposes waveforms 668 to provide multi-scale components 669.

At 906, inference engine 610 uses ML model 660 to predict outcome 662 of the analog circuit simulation of circuit design 664 based on waveforms 668 and multi-scale components 669. Where method 800 trains multiple ML models 660 for respective stages of the analog circuit simulation, inference engine 610 may use the multiple ML models 660 to predict outcome 662 at respective stages of the analog circuit simulation, such as described above with reference to FIG. 2,

At 908, computing platform 600 may determine whether to prematurely terminate the analog circuit simulation of circuit design 664 based on predicted outcome(s) 662.

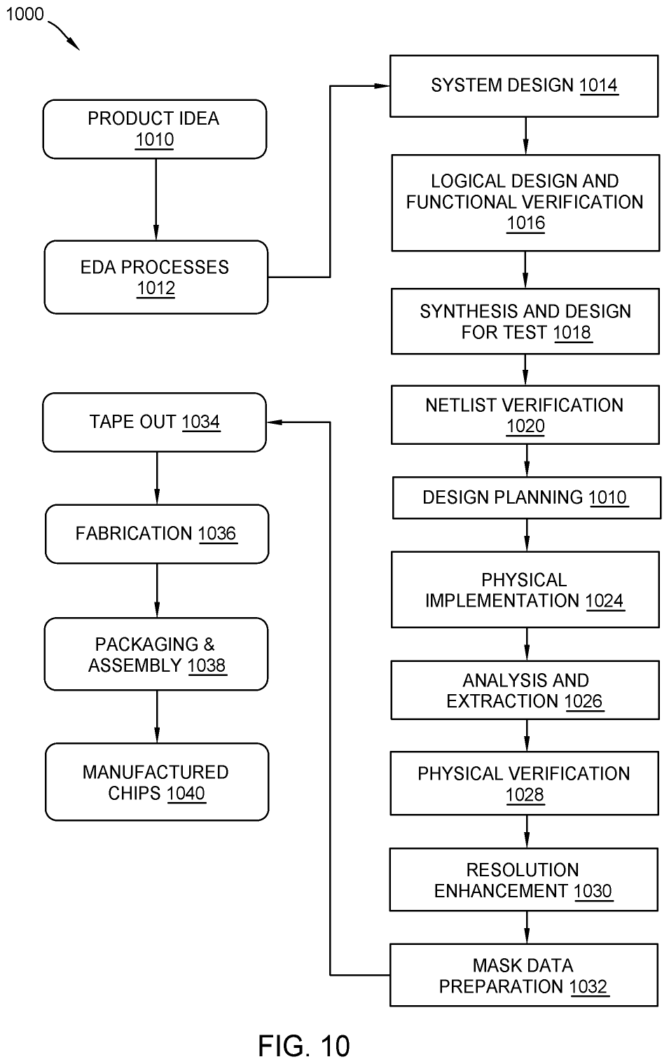

FIG. 10 illustrates an example set of processes 1000 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 1010 with information supplied by a designer, information which is transformed to create an article of manufacture that uses a set of EDA processes 1012. When the design is finalized, the design is taped-out 1034, which is when artwork (e.g., geometric patterns) for the integrated circuit is sent to a fabrication facility to manufacture the mask set, which is then used to manufacture the integrated circuit. After tape-out, a semiconductor die is fabricated 1036 and packaging and assembly processes 1038 are performed to produce the finished integrated circuit 1040.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or Open Vera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 10. The processes described by be enabled by EDA products (or EDA systems).

During system design 1014, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 1016, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as test bench generators, static HDL checkers, and formal verifiers. In some embodiments, special systems of components referred to as ‘emulators’ or ‘prototyping systems’ are used to speed up the functional verification.

During synthesis and design for test 1018, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 1020, the netlist is checked for compliance with timing constraints and for correspondence with the HDL code. During design planning 1022, an overall floor plan for the integrated circuit is constructed and analyzed for timing and top-level routing.

During layout or physical implementation 1024, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 1026, the circuit function is verified at the layout level, which permits refinement of the layout design. During physical verification 1028, the layout design is checked to ensure that manufacturing constraints are correct, such as DRC constraints, electrical constraints, lithographic constraints, and that circuitry function matches the HDL design specification. During resolution enhancement 1030, the geometry of the layout is transformed to improve how the circuit design is manufactured.

During tape-out, data is created to be used (after lithographic enhancements are applied if appropriate) for production of lithography masks. During mask data preparation 1032, the ‘tape-out’ data is used to produce lithography masks that are used to produce finished integrated circuits.

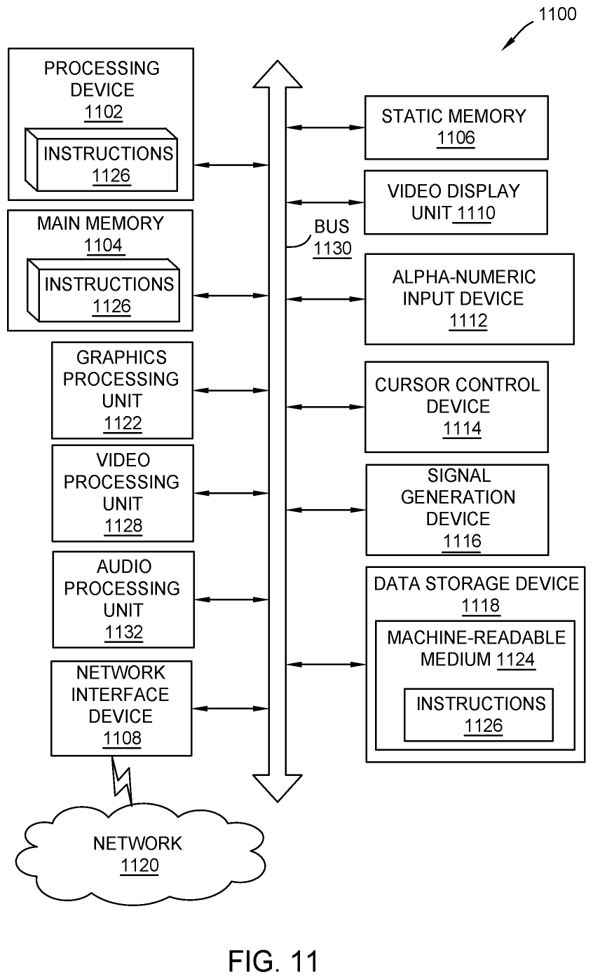

A storage subsystem of a computer system (such as computer system 1100 of FIG. 11) may be used to store the programs and data structures that are used by some or all of the EDA products described herein, and products used for development of cells for the library and for physical and logical design that use the library.

FIG. 11 illustrates an example machine of a computer system 1100 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1100 includes a processing device 1102, a main memory 1104 (e.g., read-only memory (ROM), flash memory, dynamic random access memory (DRAM) such as synchronous DRAM (SDRAM), a static memory 1106 (e.g., flash memory, static random access memory (SRAM), etc.), and a data storage device 1118, which communicate with each other via a bus 1130.

Processing device 1102 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1102 may also be one or more special-purpose processing devices such as an application specific integrated circuit (ASIC), a field programmable gate array (FPGA), a digital signal processor (DSP), network processor, or the like. The processing device 1102 may be configured to execute instructions 1126 for performing the operations and steps described herein.

The computer system 1100 may further include a network interface device 1108 to communicate over the network 1120. The computer system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), a graphics processing unit 1122, a signal generation device 1116 (e.g., a speaker), graphics processing unit 1122, video processing unit 1128, and audio processing unit 1132.

The data storage device 1118 may include a machine-readable storage medium 1124 (also known as a non-transitory computer-readable medium) on which is stored one or more sets of instructions 1126 or software embodying any one or more of the methodologies or functions described herein. The instructions 1126 may also reside, completely or at least partially, within the main memory 1104 and/or within the processing device 1102 during execution thereof by the computer system 1100, the main memory 1104 and the processing device 1102 also constituting machine-readable storage media.

In some implementations, the instructions 1126 include instructions to implement functionality corresponding to the present disclosure. While the machine-readable storage medium 1124 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1102 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method, comprising:
determining differences between waveforms generated during analog circuit simulations of a circuit design and fault-injected instances of the circuit design;
labeling the waveforms generated during the analog circuit simulations of the fault-injected instances of the circuit design based on the differences; and
training, by a processing device, a machine learning (ML) model to predict the labels based on the waveforms generated during the analog circuit simulations of the circuit design and the fault-injected instances of the circuit design.

2. The method of claim 1, further comprising:
predicting an outcome of a subsequent analog circuit simulation of a fault-injected instance of the circuit design based on the ML model and waveforms generated during the subsequent analog circuit simulation.

3. The method of claim 2, wherein:
the training the ML model comprises training multiple ML models based on waveforms generated during multiple respective stages of the analog circuit simulations of the circuit design and the fault-injected instances of the circuit design; and
the predicting comprises predicting the outcome of the subsequent analog circuit simulation at corresponding stages of the subsequent analog circuit simulation based on the respective ML models and waveforms generated during the respective stages of the subsequent analog circuit simulation.

4. The method of claim 1, wherein the training comprises:
training the ML model based further on multiscale components of the waveforms generated during the analog circuit simulations of the circuit design and the fault-injected instances of the circuit design.

5. The method of claim 1, wherein the training the ML model comprises:
training convolutional neural network (CNN) layers of the ML model, by the processing device, based on unlabeled training data that comprises waveforms generated during analog circuit simulations of a simplified circuit design and fault-injected instances of the simplified circuit design, wherein the simplified circuit design comprises a simplified version of the circuit design;
determining inputs to a binary classifier of the ML model based on trained filter parameters of the CNN layers; and
training the binary classifier to predict the labels based on the waveforms generated during the analog circuit simulations of the circuit design and the fault-injected instances of the circuit design.

6. The method of claim 5, wherein the training the ML model further comprises:
training the ML model based on waveforms generated during analog circuit simulations of i fault-injected instance of the circuit design and j fault-injected instances of the simplified circuit design;
wherein i and j are positive integers; and
wherein j is greater than i.

7. The method of claim 5, wherein:
the training the binary classifier comprises training fully connected (FC) layers of the binary classifier, layer-by-layer, based on a random-sparse-matrix-based ELM autoencoder; and
the training the CNN layers comprises training the CNN layers, layer-by-layer, based on an extreme learning machine (ELM) autoencoder.

8. The method of claim 5, further comprising:
estimating likelihoods of faults of the circuit design based on weighted random sampling; and
selecting a subset of the faults for the fault-injected instances of the circuit design and for the fault-injected instances of the simplified circuit design based on the corresponding likelihoods.

9. The method of claim 5, wherein the training the CNN layers comprises training the CNN layers based further on multiscale components of the waveforms generated during the analog circuit simulations of the simplified circuit design and the fault-injected instances of the simplified circuit design.

10. A non-transitory computer readable medium comprising stored instructions, which when executed by a processor, cause the processor to:
determine differences between waveforms generated during analog circuit simulations of a circuit design and fault-injected instances of the circuit design;
label the waveforms generated during the analog circuit simulations of the fault-injected instances of the circuit design based on the corresponding differences; and
train a machine learning (ML) model to predict the labels based on the waveforms generated during the analog circuit simulations of the fault-injected instances of the circuit design.

11. The non-transitory computer readable medium of claim 10, wherein the instructions, when executed by the processor, further cause the processor to:
train convolutional neural network (CNN) layers of the ML model based on unlabeled training data that comprises waveforms generated during analog circuit simulations of a simplified circuit design and fault-injected instances of the simplified circuit design, wherein the simplified circuit design comprises a simplified version of the circuit design;
determine inputs to a classifier of the ML model based on trained filter parameters of the CNN layers; and
train fully connected (FC) layers of the classifier to predict the labels based on the waveforms generated during the analog circuit simulations of the circuit design and the fault-injected instances of the circuit design.

12. The non-transitory computer readable medium of claim 11, wherein the instructions, when executed by a processor, further cause the processor to:
train the ML model based on waveforms generated during analog circuit simulations of i fault-injected instance of the circuit design and j fault-injected instances of the simplified circuit design;
wherein i and j are positive integers; and
wherein j is greater than i.

13. The non-transitory computer readable medium of claim 11, wherein the instructions, when executed by the processor, further cause the processor to:
train the CNN layers, layer-by-layer, based on an extreme learning machine (ELM) autoencoder; and
train the FC layers, layer-by-layer, based on a random-sparse-matrix-based ELM autoencoder.

14. The non-transitory computer readable medium of claim 11, wherein the instructions, when executed by the processor, further cause the processor to:
estimate likelihoods of faults of the circuit design based on weighted random sampling; and
select a subset of the faults for the fault-injected instances of the circuit design and for the fault-injected instances of the simplified circuit design based on the corresponding likelihoods.

15. The non-transitory computer readable medium of claim 12, wherein the instructions, when executed by the processor, further cause the processor to:
train the ML model based further on multiscale components of the waveforms.

16. A system, comprising:
memory configured to store instructions, and a processor configured to execute the instructions, wherein the instructions, when executed, cause the processor to:
perform analog circuit simulations of a circuit design and fault-injected instances of the circuit design, and output waveforms generated by the circuit design and the fault-injected instances of the circuit design during the respective analog circuit simulations,
decompose the waveforms into multiscale components,
determine differences between the waveforms generated by the circuit design and the corresponding waveforms generated by the fault-injected instances of the circuit design, and differences between the respective multiscale components,
label the waveforms generated by the fault-injected circuit designs and the corresponding multiscale components based on the respective differences, and
train a machine learning (ML) model to predict the labels based on the waveforms generated by the circuit design and the fault-injected instances of the circuit design, and the multiscale components.

17. The system of claim 16, wherein the instructions, when executed, further cause the processor to:
train convolutional neural network (CNN) layers of the ML model based on unlabeled training data that comprises waveforms generated during analog circuit simulations of a simplified circuit design and fault-injected instances of the simplified circuit design, and multiscale components of the waveforms, wherein the simplified circuit design comprises a simplified version of the circuit design;
determine inputs to a classifier of the ML model based on trained filter parameters of the CNN layers; and
train fully connected (FC) layers of the classifier to predict the labels based on the waveforms generated by the circuit design and fault-injected instances of the circuit design and the corresponding multiscale components.

18. The system of claim 17, wherein the instructions, when executed, further cause the processor to:
train the CNN layers, layer-by-layer, based on an extreme learning machine (ELM) autoencoder; and
train the FC layers, layer-by-layer, based on a random-sparse-matrix-based ELM autoencoder.

19. The system of claim 17, wherein the instructions, when executed, further cause the processor to:
estimate likelihoods of faults of the circuit design based on weighted random sampling; and
select a subset of the faults for the fault-injected instances of the circuit design and for the fault-injected instances of the simplified circuit design based on the corresponding likelihoods.

20. The system of claim 17, wherein the instructions, when executed, further cause the processor to:
train the ML model based on waveforms generated during analog circuit simulations of i fault-injected instance of the circuit design and j fault-injected instances of the simplified circuit design;
wherein i and j are positive integers; and
wherein j is greater than i.
